(19) United States
(12) Patent Application Publication
(10) Pub. No.: US 2008/0317156 A1
(43) Pub. Date: Dec. 25, 2008

(54) METHOD AND APAPRATUS FOR REDUCING UPDATING RATE OF CHANNEL STATUS IN A COMMUNICATION SYSTEM

(75) Inventors: Kathiravetpillai SIVANESAN, Suwon-si (KR); Ho-Kyu CHOI, Seongnam-si (KR); Dong-Seek PARK, Yongin-si (KR); Hung-Tuan NGUYEN, Aalborg (DK); Tim BROWN, Aalborg (DK); Patrick Claus Friedrich EGGERS, Aalborg (DK); Persefoni KYRITSI, Aalborg (DK)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 12/041,221

(22) Filed: Mar. 3, 2008

(30) Foreign Application Priority Data
Mar. 2, 2007 (KR) 21187-2007

(51) Int. Cl. H04B 7/02

(52) U.S. Cl. 375/267

(57) ABSTRACT

A method and apparatus for reducing a channel updating rate in a communication system are provided, in which a channel matrix H representing a channel status of physical channels is acquired, eigenvectors of the channel matrix H are output by a Singular Value Decomposition (SVD) of the channel matrix H, and when at least one of the eigenvectors has a phase inversion, the phase inversion is removed from the eigenvector.

### PRIORITY

This application claims priority under 35 U.S.C. § 119(a) to a Korean Patent Application filed in the Korean Intellectual Property Office on Mar. 2, 2007 and assigned Serial No. 2007-21187, the entire disclosure of which is incorporated herein by reference.

### BACKGROUND OF THE INVENTION

1. Field of the Invention

The present invention generally relates to a communication system. More particularly, the present invention relates to a method and apparatus for reducing an updating rate of the channel status of a physical channel in a data transmission/reception state.

2. Description of the Related Art

To increase the channel capacity of a Multiple Input Multiple Output (MIMO) communication system, accurate tracking of the orthogonal eigenmodes of the channel status of a physical channel as a Mobile Station (MS) is moving is vital. Resolving the eigenmodes requires Singular Value Decomposition (SVD) computation, which is generally not possible within the short time spaces between input samples. SVD decomposes an M×N matrix A of the physical channel into an M×M orthogonal matrix U, an M×N matrix S with non-negative diagonal elements, and an N×N orthogonal matrix V.

FIG. 1 illustrates a conventional subspace tracking method.

Referring to FIG. 1, in the conventional subspace tracking method, matrices U′ and V′, for physical channels after Tₚ, are estimated using pilot/updating eigenmodes; U, S and V are derived from a channel matrix H by an SVD. H is a channel matrix representing a channel status of the physical channels and Tₚ is a pilot period.

FIG. 2A illustrates a conventional method for using SVD in an MS.

Referring to FIG. 2A, an MS 200 acquires Channel State Information (CSI) about the channel matrix H of physical channels from a Base Station (BS) 205. An SVD calculator 202 outputs matrices U and V related to the channel matrix H by SVD of the CSI. The MS 200 transmits the matrix V as a CSI feedback to the BS 205.

FIG. 2B illustrates a conventional method for using SVD in both an MS and a BS.

Referring to FIG. 2B, an MS 210 and a BS 215 already have knowledge of the CSI of the channel matrix H of physical channels. The MS 210 provides the CSI to an SVD calculator 212 and the SVD calculator 212 calculates a matrix U by an SVD of the CSI. The BS 215 provides the CSI to an SVD calculator 217 and the SVD calculator 217 calculates a matrix V by an SVD of the CSI. There is no need to feed back the matrices V and U between the MS 210 and the BS 215.

SVD decomposes the M×N channel matrix H into Equation (1)

H=USV^{H} (1)

where U, S, and V are the eigen domain components of the M×N channel matrix H. To achieve the matrix H to which SVD is applied, the columns of the matrices U and V being orthogonal eigenvectors will be tracked. The diagonal elements of the matrix S, which are Singular Values (SVs), are represented as Equation (2). Many applications of SVDs are found in signal processing and statistics.

S=diag(s₁, s₂, . . . , sᵣ)_{min(M,N)} (2)

In general, most of the SVD solutions used in MATLAP, MAPLE, etc. apply the Linear Algebra PACKage (LAPACK) algorithm. However, SVD in LAPACK is implemented in the interests of LAPACK's own efficiency. In other words, LAPACK emphasizes an optimization solution for each individual input matrix, which may be efficient for Monte Carlo simulations but may not be efficient for a system with a memory. Hence, optimal second-order statistics that will matter to subspace tacking are required. Therefore, the matrices U, S, and V as solutions of SVD have a larger dynamic and/or spectrum than the sequence of correlated matrices, H at the input due to the output of the LAPACK solution.

Another factor in using LAPACK is that the SVs are always in a descending order. In order to maintain the descending order, there are cases where the eigenmodes swap positions and cause significant discontinuities in the change of state of a single eigenvector.

If an SVD solution can be modified to suit a wireless MIMO system with a memory, the following benefits can be foreseen:

1. A proper SVD factorization significantly increases the pilot period, Tₚ, so that the channel updating frequency is reduced.

2. The modified SVD assists in designing a feedback delay in the time domain protocol with respect to the CSI.

3. As the number of pilot eigenvectors is reduced in the frequency domain, the system spectral efficiency is improved.

The SVD implementations applying LAPACK and similar algorithms will output ordered SVs corresponding to eigenvectors. Since the eigenvectors have extensive discontinuities in both magnitude and phase at various points, high Doppler spread is created in comparison to the physical channels.

Therefore, the relations between eigenspaces are not taken into account and this matter has been previously identified on a mathematical level, showing greater levels of variation in the decomposed domain compared to the original input.

Recent research has shown how changing the order of the SVs to their natural unordered form can significantly improve vector dynamics. This work also considers the distribution of phase between the eigenvectors and SVs, but does not consider the optimum cases for this and the process is iterative, which lacks efficiency suitable for implementation.

### SUMMARY OF THE INVENTION

An aspect of exemplary embodiments of the present invention is to address at least the problems and/or disadvantages and to provide at least the advantages described below. Accordingly, an aspect of exemplary embodiments of the present invention is to provide a method and apparatus for easing rapid fading on eigenmodes found with SVD.

Moreover, an aspect of exemplary embodiments of the present invention provides a method and apparatus for tracking eigenspaces on a moving multipath channel.

In accordance with an aspect of exemplary embodiments of the present invention, there is provided a method for reducing a channel updating rate in a communication system, in which a channel matrix H representing a channel status of physical channels is acquired, eigenvectors of the channel matrix H are output by a Singular Value Decomposition (SVD) of the channel matrix H, and if at least one of the eigenvectors has a phase inversion, the phase inversion is removed from the eigenvector.

In accordance with another aspect of exemplary embodiments of the present invention, there is provided a method for reducing a channel updating rate in a communication system, in which a channel matrix H representing a channel status of physical channels is acquired, eigenvectors of the channel matrix H are output by an SVD of the channel matrix H, and phases of the eigenvectors are corrected so that phases of neighboring eigenvectors in a time domain among the eigenvectors have a smallest gradient.

In accordance with a further aspect of exemplary embodiments of the present invention, there is provided a method for reducing a channel updating rate in a communication system, in which a channel matrix H representing a channel status of physical channels is acquired, eigenvectors of the channel matrix H are output by SVD of the channel matrix H, and if an unwanted eigenvector swap is detected in the channel matrix H, the eigenvectors are re-ordered.

In accordance with still another aspect of exemplary embodiments of the present invention, there is provided an apparatus for reducing a channel updating rate in a communication system, in which an SVD calculator acquires a channel matrix H representing a channel status of physical channels and outputs eigenvectors of the channel matrix H by an SVD of the channel matrix H, and if at least one of the eigenvectors has a phase inversion, a phase inversion remover removes the phase inversion from the eigenvector.

In accordance with yet another aspect of exemplary embodiments of the present invention, there is provided an apparatus for reducing a channel updating rate in a communication system, in which an SVD calculator acquires a channel matrix H representing a channel status of physical channels and outputs eigenvectors of the channel matrix H by an SVD of the channel matrix H, and a phase shifter corrects phases of the eigenvectors so that phases of neighboring eigenvectors in a time domain among the eigenvectors have a smallest gradient.

In accordance with yet further aspect of exemplary embodiments of the present invention, there is provided an apparatus for reducing a channel updating rate in a communication system, in which an SVD calculator acquires a channel matrix H representing a channel status of physical channels and outputs eigenvectors of the channel matrix H by SVD of the channel matrix H, and a re-orderer, if an unwanted eigenvector swap is detected in the channel matrix H, re-orders the eigenvectors.

### BRIEF DESCRIPTION OF THE DRAWINGS

The above and other objects, features and advantages of certain exemplary embodiments of the present invention will be more apparent from the following detailed description taken in conjunction with the accompanying drawings, in which:

FIG. 1 illustrates a conventional subspace tracking method;

FIG. 2A illustrates a conventional method for using SVD in an MS;

FIG. 2B illustrates a conventional method for using SVD in both an MS and aBS;

FIG. 3 illustrates an example of the phase characteristics of decomposed data;

FIG. 4 illustrates removal of phase inversions for eigenvector elements according to an exemplary embodiment of the present invention;

FIG. 5 illustrates combining physical channels between an MS and a BS according to a fourth exemplary embodiment of the present invention;

FIG. 6 is a flowchart illustrating the complete construction of the exemplary embodiments of the present invention cascaded together;

FIG. 7A is a block diagram of an MS and BS according to an exemplary embodiment of the present invention;

FIG. 7B is a block diagram of an MS and BS according to another exemplary embodiment of the present invention;

FIG. 8 is a graph illustrating the cumulative distributions of the phase of U according to exemplary embodiments of the present invention; and

FIG. 9 is a graph illustrating the cumulative distributions of the phase of V according to exemplary embodiments of the present invention.

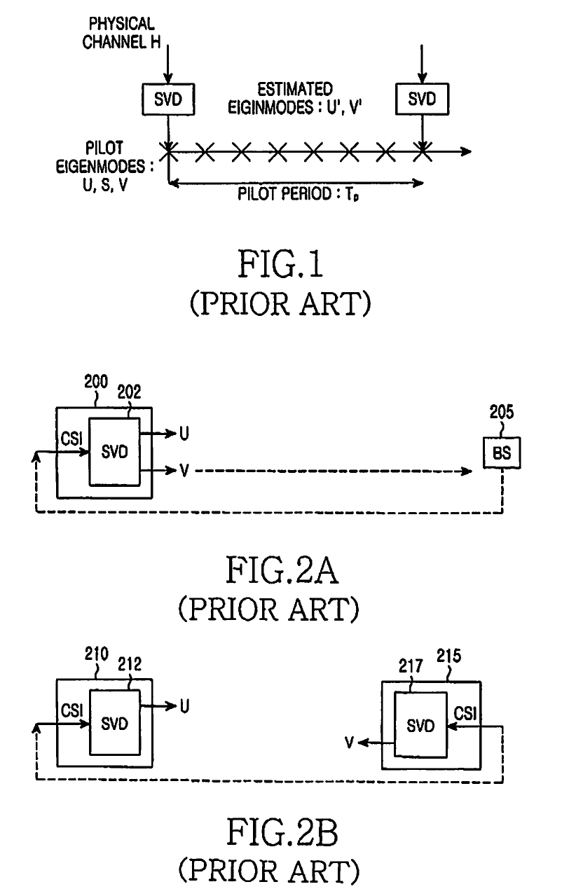

Throughout the drawings, the same drawing reference numerals will be understood to refer to the same elements, features and structures.

### DETAILED DESCRIPTION OF EXEMPLARY EMBODIMENTS

The matters defined in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Exemplary embodiments of the present invention employ techniques that satisfy equation (1) while still maintaining the unitary and orthogonal nature of eigenvectors, when considering the output of decomposed channel data of multi-path channels in a MIMO communication system. While the present invention will be described in the context of a communication system supporting a 2×2 MIMO channel, the present invention is also applicable to other communication systems. The techniques have the following effects.

1. The phase can be distributed freely between eigenvectors. If the phase of a first eigenvector is shifted, the phase of a second eigenvector can likewise be shifted in the opposite direction by the same amount. The overall phase shift therefore stays the same.

2. SVs are normally real, though it is also possible to make the SVs complex so as to share some of the phase applied to the eigenvectors.

3. Though the SVs are normally in a descending order, they can be re-arranged in any desired order and still be assembled into the same channel as long as the SVs respective eigenvectors are in the same order.

Further, it is also possible that input channel data representing channel status can be manipulated so as to avoid or reduce chances of unwanted incidents in the decomposed domain, which requires knowledge of establishing the links between behaviors of physical and decomposed data.

In accordance with an exemplary embodiment of the present invention, the phases of eigenmode elements are directly re-distributed to ensure that no phase inversion occurs.

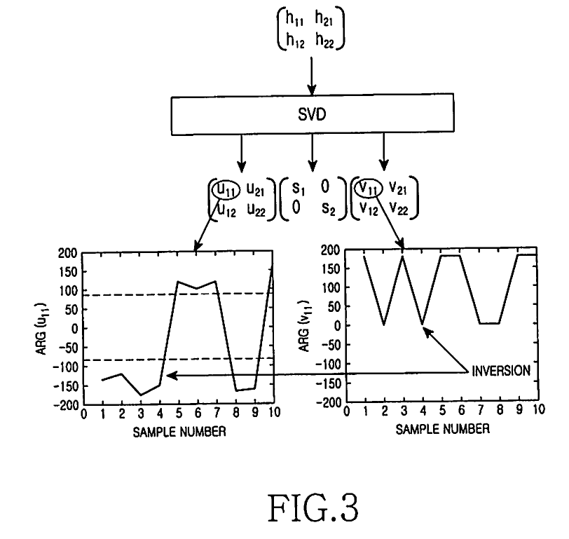

FIG. 3 illustrates an example of the phase characteristics of decomposed data.

Referring to FIG. 3, a channel H of a 2×2 MIMO channel-based wireless communication system takes the form of a 2×2 matrix having elements, h₁₁, h₁₂, h₂₁, and h₂₂. The channel H is decomposed into eigenvectors U, S and V described in Equation (1) each being a 2×2 matrix. The matrix U has elements u₁₁, u₁₂, u₂₁ and u₂₂, the matrix S has elements s₁, 0, 0 and s₂, and the matrix V has elements v₁₁, v₁₂, v₂₁ and v₂₂.

In FIG. 3, v₁₁ switches from 0° to 180°, whenever the phase of u₁₁ enters a first region between −90° and +90°. That is, in the typical SVD computation based on the LAPACK algorithm, the phase of V is discontinuous due to re-ordering within LAPACK. To track this phase change, the feedback period of V should be shorter than the phase change. Therefore, the present invention removes phase inversions by assuming that the phase of u₁₁ is outside the first region, although the phase of u₁₁ enters the first region.

Consequently, a typical SVD equation, Equation (3), is modified to form Equation (4). When phase inversions are detected, they are removed by modifying the phase output of the eigenmode elements using the first element, h₁₁ of a 2×2 MIMO channel, computed by Equation (4).

h₁₁=u₁₁s₁v₁₁*+u₂₁s₂v₂₁* (3)

h₁₁=(u₁₁sign(v₁₁))s₁(v₁₁*sign(v₁₁))+(u₂₁sign(v₂₁))s₂(v₂₁*sign(v₂₁)) (4)

where s₁ and s₂ are the SVs and the sign function returns the polarity of an input number.

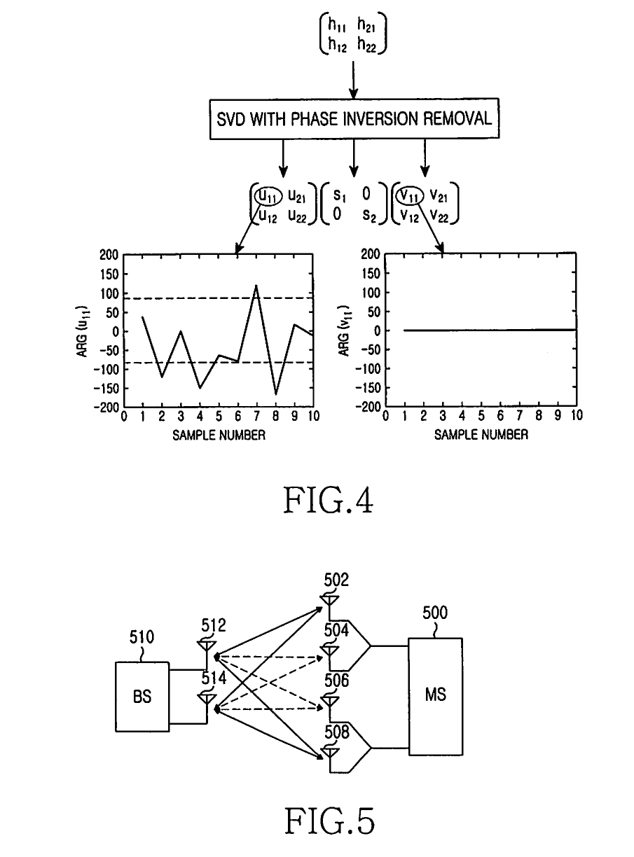

FIG. 4 illustrates removal of phase inversions for eigenvector elements according to an exemplary embodiment of the present invention.

Referring to FIG. 4, a 2×2 MIMO channel is decomposed into matrices U, S, and V by an SVD computation with phase inversions removed. An element, v₁₁ of the matrix V has no phase, i.e., v₁₁ has a phase of 0 all the time. As the phase inversion of v₁₁ is removed, the phase of u₁₁ is changed to maintain the overall phase, as compared to FIG. 3. However, since u₁₁ is not fed back, the phase change of u₁₁ does not affect the amount of the feedback. The eigenvector elements of U and V satisfy the following conditions:

(1) The Doppler spread of the individual eigenvector elements is reduced dramatically and now comparable to that of the channel. Therefore the necessary sampling rate will be reduced to avoid aliasing.

(2) A link exists between the phases of the eigenvectors U and V. However, their magnitudes are not linked, as they are independent.

In accordance with another exemplary embodiment of the present invention, the phases of the eigenmode elements are modified to ensure a smallest gradient between two neighboring eigenvector elements.

Phase discontinuities can be removed by distributing the phase between the columns of U and V, where the phase of these eigenvectors arrive at a smoothness transition between the two neighboring samples in the time domain, such that the phases of two neighboring eigenvectors in the time domain have a minimum gradient, preferably 0. Further, it is also possible to spread some of the phase into the SVs.

That is, without considering the phase distribution into the elements of S, the phases between U and V are distributed so that, for example, for a time index n, the phase of the change in state u₁^{H}(n)u₁(n−1) and v₁^{H}(n)v₁(n−1) is at a minimum. Here, u₁ and v₁ are eigenvectors of U and V. Consequently, as U and V change from one state to another, the fading of the phase on the eigenvectors slows down.

A sub-optimum mode can be set so that

max[real(u₁^{H}(n)u₁(n−1))+real(v₁^{H}(n)v₁(n−1))] (5)

That is, the sum of the real value of the state u₁^{H}(n)u₁(n−1) and the real value of the state v₁^{H}(n)v₁(n−1) is at a maximum. As a result, v₁^{H}(n)v₁(n−1) has a moderate phase variation and u₁^{H}(n)u₁(n−1) has no phase variation.

Computation of the sub-optimum mode described in Equation (5) can easily be performed without iteration, if the eigenvector u₁(n) is easily changed to u′₁(n) such that

u′₁(n)=u₁(n)e^{jφ} (6)

where φ is computed by

φ=−arg(u₁^{H}(n)u₁(n−1)) (7)

Then if the eigenvector v₁(n) is changed to an eigenvector v′₁(n) such that

v′₁(n)=v₁(n)e^{-jφ} (8)

the eigenvector will have a rapidly reduced phase variation, when compared to the eigenvector's next state.

The same process can be applied to the remaining eigenvectors, u₂ . . . u_{N} and v₂ . . . v_{N} by applying Equation (5) to Equation (8) in the same manner. Hence, with a simple operation requiring only information of the current and previous statuses, extensive iterative procedures are avoided and a maximum reduction is achieved in the phase change from state-to-state for the eigenvectors.

It is also possible that the remaining phase of vⱼ^{H}(n)vⱼ(n−1) can be offloaded either completely or in part to the SVs for all values of an eigenvector index j. Consequently, the SVs become complex and therefore have a dynamic phase delay, which can be removed by simple phase shifting at detection. Several phase constellations can be chosen from different implementations where this concept has suitable flexibility.

A third exemplary embodiment of the present invention provides an eigen domain swapping detection method and a physical data manipulation method.

Through analyzing the behavior of the physical channel data in relation to the decomposed data, it has been identified that certain scenarios occur which will cause the decomposed data to behave in certain ways. For example, when there is an unwanted vector swap caused by an ordering of eigenmodes, the magnitudes of channel paths converge towards each other and become close to equal along with a phase inversion between eigen elements.

The eigenvector swap detection can be represented as a Gram matrix defined by Equation (9)

G=H^{H}H (9)

In a 2×2 MIMO case, when g₁₁=g₂₂ in the matrix G, the system determines that a vector swap has occurred in the channel matrix H. Equation (9) is applied as a direct case to identify where the channel is approaching an eigenvector swap, which can apply to unordering the eigenmodes.

In accordance with a fourth exemplary embodiment of the present invention, a predetermined number of physical channels are combined between an MS and a BS. Thus, the chance of eigenvector ordering according to the first exemplary embodiment of the present invention is reduced, thereby significantly decreasing the phase change between eigenvector states.

FIG. 5 illustrates combining physical channels between an MS and a BS according to the fourth exemplary embodiment of the present invention.

Referring to FIG. 5, an MS 500 has four antennas 502, 504, 506 and 508, and a BS 510 has two antennas 512 and 514.

To provide a 2×2 MIMO link for channel communications between the MS 500 and the BS 510, each of the BS antennas 512 and 514 is correlated with two of the MS antennas 502, 504, 506 and 508. Therefore there are two channels, H_{A} and H_{B} that are combined together. The resultant channel reduces the chance of eigenmode swapping, i.e., eigenvector dynamics are significantly improved with a highly reduced chance of eigenvector swapping. Thus the natural paths of the eigenstates are always ordered. Also, The Signal to Noise Ratio (SNR) of sub-channels is improved.

While this scheme has obviously the disadvantage of requiring more antenna branches and possibly transceivers at the MS or the BS, many other combining schemes not yet investigated could hold a greater advantage in this regard. Further, the combining scheme has a strong antenna field pattern influence (both in gain and phase) on the eigenvector dynamics.

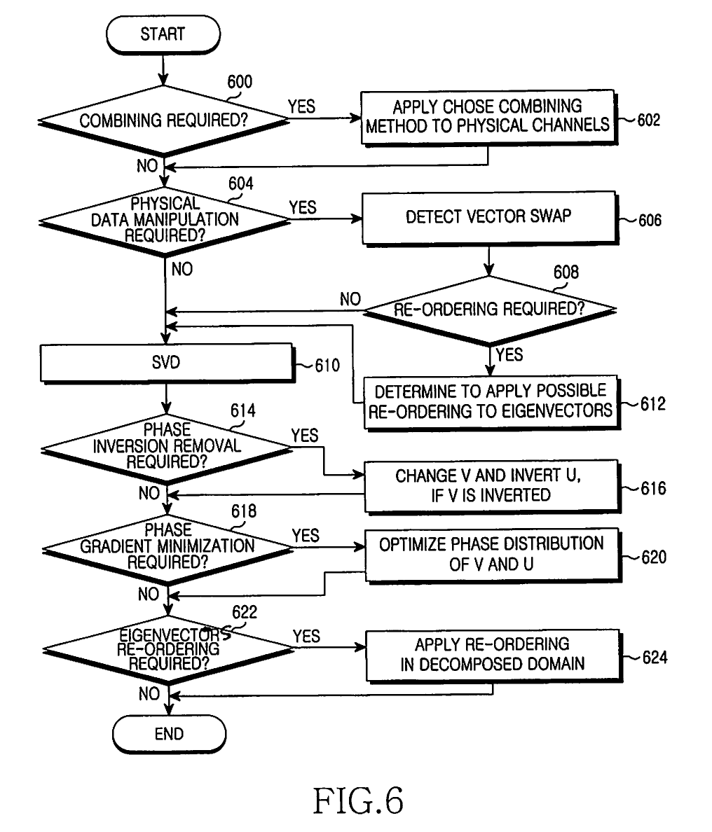

FIG. 6 is a flowchart illustrating the complete construction of the exemplary embodiments of the present invention cascaded together.

Referring to FIG. 6, the phase inversions and phase corrections proposed in the first and second exemplary embodiments of the present invention are applied to create eigenvectors U′ and V′ at the SVD outputs. The SVD algorithm can contain a suitable unordering algorithm like the third exemplary embodiment of the present invention. If the SVs are complex, a phase shift, φₑ is applied. The input CSI is also modified for the purpose of enhancing the link quality. The four exemplary embodiments of the present invention are used independently according to standards or system setting, not to affect one another.

Referring to FIG. 6, the system monitors whether a combination of existing physical channels between an MS and a BS is required in step 600. If a combination is required, the system applies a chosen combining method to the physical channels, thereby modifying a channel matrix in step 602 and proceeds to step 604. For example, if the system chooses the 2×2 MIMO link as the combining method as illustrated in FIG. 5, the physical channels between the antennas of the MS and the BS are combined by twos.

On the contrary, if a combination is not required, the system monitors whether physical data manipulation is required according to Equation (9) in step 604. If physical data manipulation is required, the system proceeds to step 606 and otherwise, the system proceeds to step 610, which corresponds to the third exemplary embodiment of the present invention. Step 610 is performed for the purpose of re-ordering the paths of eigenvectors, when an unwanted eigenvector swap occurs by ordering of the eigenvectors.

In step 606, the system calculates the matrix G by Equation (9) and determines whether g₁₁=g₂₂ in the matrix G, in order to determine whether an eigenvector swap has occurred, i.e., whether the state of the physical channel data is close to eigenvector re-ordering. If g₁₁=g₂₂, the system proceeds to step 612, considering that re-ordering is required due to a detected eigenvector swap. Otherwise, the system proceeds to step 610. In step 612, the system determines that re-ordering of the eigenvectors decomposed from the physical channel data is required and then proceeds to step 610.

In step 610, the system calculates an SVD of the channel matrix H of the physical channel data. The SVD computation decomposes the channel matrix H of the physical channels into eigenvectors U, S, and V by Equation (1) and Equation (2).

In step 614, the system determines whether phase inversion removal is required for the phases of the eigenvectors. If the phase inversion removal is required, the system proceeds to step 616 and otherwise, the system proceeds to step 618. For a phase-inverted eigenvector, the system removes the phase inversion from the eigenvector by Equation (4) in the first exemplary embodiment of the present invention in step 616.

The system determines whether phase gradient reduction is required in step 618. If the phase gradient reduction is required, the system proceeds to step 620 and otherwise, the system proceeds to step 622. The system optimizes the phase distributions of the eigenvectors V and U based on their previous values by Equation (8) and Equation (5), respectively, thus creating V′ and U′ and forms U and V with minimized gradients by Equation (5).

In step 622, the system determines whether a reordering of the eigenvectors is required. If a reordering of the eigenvectors is required, the system proceeds to step 624 and otherwise, the system ends the algorithm. This determination can be made by the decision of step 612 or in any other way. In step 624, the system applies re-ordering to the eigenvectors based on the physical channel data in the decomposed domain. For example, the eigenvectors are re-ordered according to the magnitudes of the eigenvectors.

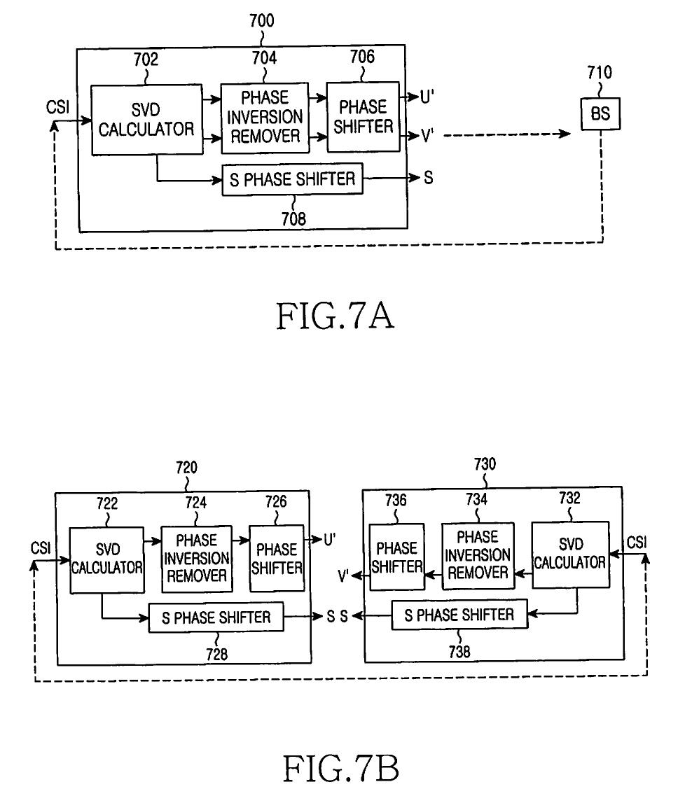

FIG. 7A is a block diagram of an MS and BS according to an exemplary embodiment of the present invention. In the illustrated case of FIG. 7A, the channel updating scheme of the present invention applies to only the MS.

Referring to FIG. 7A, an MS 700 includes an SVD calculator 702, a phase inversion remover 704, a phase shifter 706, and an S phase shifter 708.

The SVD calculator 702, which has acquired CSI representing the channel matrix H of existing physical channels from a BS 710, computes eigenvectors U, S and V by Equation (1) and orders the eigenvectors when needed. The SVD calculator 702 provides U and V to the phase inversion remover 704 and S to the S phase shifter 708. The phase inversion remover 704 determines whether the phases of the elements of U and V have been inverted. If the element phase inversion is detected, the phase inversion remover 704 removes the phase inversion in U and V so that the phases are positioned in predetermined phase regions. The phase shifter 706 shifts the phases of U and V received from the phase inversion remover 704 such that their phase gradients are minimized, thus producing U′ and V′. The S phase shifter 706 applies a phase shift φₑ to the SVs of S, if the SVs of S are complex. Then, V′ is fed back to the BS 710.

FIG. 7B is a block diagram of an MS and BS according to another exemplary embodiment of the present invention. In the illustrated case of FIG. 7B, the channel updating scheme of the present invention applies to both the BS and the MS.

Referring to FIG. 7B, an MS 720 includes an SVD calculator 722, a phase inversion remover 724, a phase shifter 726, and an S phase shifter 728. A BS 730 includes an SVD calculator 732, a phase inversion remover 734, a phase shifter 736, and an S phase shifter 738. It is assumed that the MS 720 and the BS 730 already have knowledge of the CSI of existing physical channels H.

In the MS 720, the SVD calculator 722 computes eigenvectors U, S, and V using the CSI by Equation (1) and orders the eigenvectors when needed. The SVD calculator 722 provides U to the phase inversion remover 724 and S to the S phase shifter 728. The phase inversion remover 724 determines whether the phases of the elements of U have been inverted. If the element phase inversion is detected, the phase inversion remover 724 removes the phase inversion in U so that the phases are positioned in predetermined phase regions. The phase shifter 726 shifts the phase of U received from the phase inversion remover 724 such that U's phase gradient is minimized, thus producing U′. The S phase shifter 726 applies a phase shift φₑ to the SVs of S, if the SVs of S are complex.

In the BS 730, the SVD calculator 732 computes eigenvectors U, S, and V using the CSI by Equation (1) and orders the eigenvectors when needed. The SVD calculator 732 provides V to the phase inversion remover 734 and S to the S phase shifter 738. The phase inversion remover 734 determines whether the phases of the elements of V have been inverted. If the element phase inversion is detected, the phase inversion remover 734 removes the phase inversion in V so that the phases are positioned in predetermined phase regions. The phase shifter 736 shifts the phase of V received from the phase inversion remover 734 such that its phase gradient is minimized, thus producing V′. The S phase shifter 736 applies a phase shift φₑ to the SVs of S, if the SVs of S are complex.

The BS generates a downlink MIMO signal using V′ and transmits the downlink MIMO signal, while the MS recovers a signal received from the BS using the MS′ stored U′.

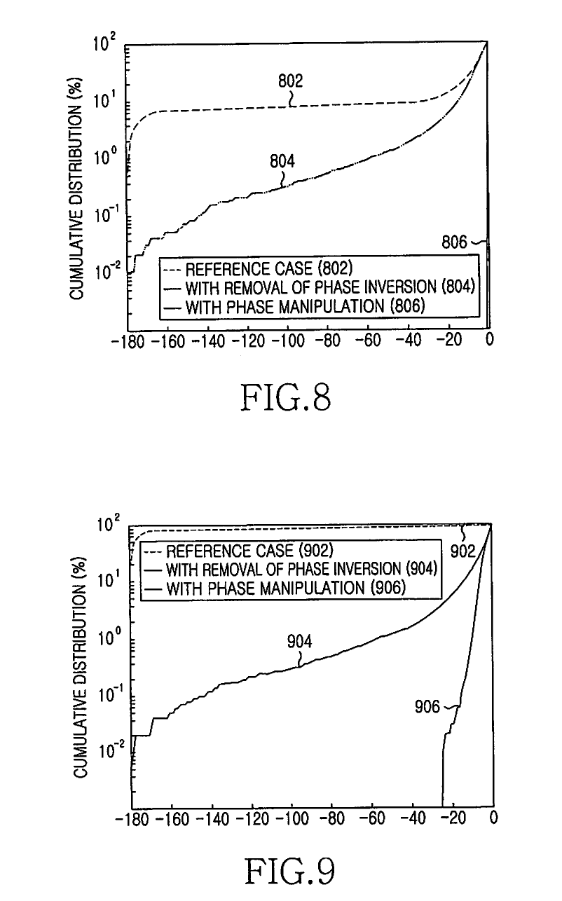

FIG. 8 is a graph illustrating the cumulative distributions of the phase of U according to an exemplary embodiment of the present invention.

Referring to FIG. 8, the cumulative distribution of the negative absolute of the phase of the state u₁^{H}(n)u₁(n−1) is shown in the case of phase inversion removal (curve 804) according to the first exemplary embodiment of the present invention and the case of phase correction (curve 806) according to the third exemplary embodiment of the present invention. Curve 804 shows a significant decrease of the negative phase, i.e., the phase inversion distribution to be almost 1/100, compared to curve 802 indicating a reference accumulative distribution. As noted from curve 806, further phase correction leads the phase inversion distribution close to 0.

FIG. 9 is a graph illustrating the cumulative distribution of the phase of V according to the first and third exemplary embodiments of the present invention.

Referring to FIG. 9, the cumulative distribution of the negative absolute of the phase of the state v₁^{H}(n)v₁(n−1) is shown in the case of phase inversion removal (curve 904) according to the first exemplary embodiment of the present invention and the case of phase correction (curve 906) according to the third exemplary embodiment of the present invention. Curve 904 shows a significant decrease of the negative phase, i.e. the phase inversion distribution to be almost 1/10000, compared to curve 902 indicating a reference accumulative distribution. As noted from curve 906, further phase correction leads to a phase inversion distribution lower than a phase inversion distribution of curve 904.

As is apparent from the above description, the present invention advantageously reduces the updating rate of a channel or eigenstate information of a MOdulator/DEModulator (MODEM) that tracks the eigenspace between pilot samples resolved by use of SVD. By proposing phase manipulation of the eigenvectors, ordering of the eigenmodes, pre-decomposition, and data manipulation, the present invention also reduces the rate of SVD computations required, computational complexity, and communication overhead, and eases fast fading on a communication channel. Furthermore, eigenspaces can be tracked accurately in a moving multipath channel.

While the invention has been shown and described with reference to certain exemplary embodiments of the present invention thereof, it will be understood by those skilled in the art that various changes in form and details may be made therein without departing from the spirit and scope of the present invention as defined by the appended claims and their equivalents.

What is claimed is:

1. A method for reducing a channel updating rate in a communication system, comprising:
acquiring a channel matrix H representing a channel status of physical channels and outputting eigenvectors of the channel matrix H by a Singular Value Decomposition (SVD) of the channel matrix H; and
removing, when at least one of the eigenvectors has a phase inversion, the phase inversion from the eigenvector.

2. The method of claim 1, wherein the removal comprises shifting a first eigenvector and shifting a second eigenvector to an opposite direction by a same amount among the eigenvectors.

3. The method of claim 2, wherein at least one of the first and second eigenvectors is one of orthogonal eigenvectors U and V resulting from the SVD of the channel matrix H.

4. The method of claim 2, wherein the removal comprises removing the phase inversion by modifying a phase output of the eigenvectors by
h₁₁=(u₁₁sign(v₁₁))s₁(v₁₁*sign(v₁₁))+(u₂₁sign(v₂₁))s₂(v₂₁*sign(v₂₁))
where h₁₁ is an element of the channel matrix H, s₁ and s₂ are singular values being diagonal elements of a matrix S resulting from the SVD of the channel matrix H, u₁₁ and u₁₂ are elements of orthogonal eigenvectors U resulting from the SVD of the channel matrix H, v₁₁ and v₁₂ are elements of orthogonal eigenvectors V resulting from the SVD of the channel matrix H, and a sign function returns the polarity of an input number.

5. The method of claim 1, further comprising combining at least a part of physical channels between a Mobile Station (MS) and a Base Station (BS) before the SVD of the channel matrix H.

6. A method for reducing a channel updating rate in a communication system, comprising:
acquiring a channel matrix H representing a channel status of physical channels and outputting eigenvectors of the channel matrix H by a Singular Value Decomposition (SVD) of the channel matrix H; and
correcting phases of the eigenvectors so that phases of neighboring eigenvectors in a time domain among the eigenvectors have a smallest gradient.

7. The method of claim 6, wherein the correction comprises correcting the phases of the eigenvectors to satisfy
max[real(u₁^{H}(n)u₁(n−1))+real(v₁^{H}(n)v₁(n−1))]
where u₁ and v₁ are orthogonal eigenvectors resulting from the SVD of the channel matrix H and n is a time index.

8. The method of claim 7, wherein eigenvectors u₁(n) and v₁(n) are changed to u₁′(n) and v₁′(n) such that
u′₁(n)=u₁(n)e^{jφ}, v′₁(n)=v₁(n)e^{-jφ}, and
φ=−arg(u₁^{H}(n)u₁(n−1)).

9. The method of claim 6, further comprising combining at least a part of physical channels between a Mobile Station (MS) and a Base Station (BS) before the SVD of the channel matrix H.

10. A method for reducing a channel updating rate in a communication system, comprising:
acquiring a channel matrix H representing a channel status of physical channels and outputting eigenvectors of the channel matrix H by a Singular Value Decomposition (SVD) of the channel matrix H; and
when an unwanted eigenvector swap is detected in the channel matrix H, re-ordering the eigenvectors.

11. The method of claim 10, further comprising when elements g₁₁ and g₂₂ of a matrix G calculated by the following equation are equal,
G=H^{H}H,
determining that the eigenvector swap has occurred.

12. The method of claim 10, further comprising combining at least a part of physical channels between a Mobile Station (MS) and a Base Station (BS) before the SVD of the channel matrix H.

13. An apparatus for reducing a channel updating rate in a communication system, comprising:
a Singular Value Decomposition (SVD) calculator adapted to acquire a channel matrix H representing a channel status of physical channels and outputting eigenvectors of the channel matrix H by an SVD of the channel matrix H; and
a phase inversion remover adapted to remove, when at least one of the eigenvectors has a phase inversion, the phase inversion from the eigenvector.

14. The apparatus of claim 13, wherein the phase inversion remover adapts to shift a first eigenvector and shifts a second eigenvector to an opposite direction by a same amount among the eigenvectors.

15. The apparatus of claim 14, wherein at least one of the first and second eigenvectors is one of orthogonal eigenvectors U and V resulting from the SVD of the channel matrix H.

16. The apparatus of claim 14, wherein the phase inversion remover adapts to remove the phase inversion by modifying a phase output of the eigenvectors by
h₁₁=(u₁₁sign(v₁₁))s₁(v₁₁*sign(v₁₁))+(u₂₁sign(v₂₁))s₂(v₂₁*sign(v₂₁))
where h₁₁ is an element of the channel matrix H, s₁ and s₂ are singular values being diagonal elements of a matrix S resulting from the SVD of the channel matrix H, u₁₁ and u₁₂ are elements of orthogonal eigenvectors U resulting from the SVD of the channel matrix H, v₁₁ and v₁₂ are elements of orthogonal eigenvectors V resulting from the SVD of the channel matrix H, and a sign function returns a polarity of an input number.

17. The apparatus of claim 13, further comprising a combiner adapted to combine at least a part of physical channels between a Mobile Station (MS) and a Base Station (BS) before the SVD of the channel matrix H.

18. An apparatus for reducing a channel updating rate in a communication system, comprising:
a Singular Value Decomposition (SVD) calculator adapted to acquire a channel matrix H representing a channel status of physical channels and outputting eigenvectors of the channel matrix H by an SVD of the channel matrix H; and
a phase shifter adapted to correct phases of the eigenvectors so that phases of neighboring eigenvectors in a time domain among the eigenvectors have a smallest gradient.

19. The apparatus of claim 18, wherein the phase shifter adapts to correct the phases of the eigenvectors to satisfy
max[real(u₁^{H}(n)u₁(n−1))+real(v₁^{H}(n)v₁(n−1))]
where u₁ and v₁ are orthogonal eigenvectors resulting from the SVD of the channel matrix H and n is a time index.

20. The apparatus of claim 19, wherein eigenvectors u₁(n) and v₁(n) are changed to u₁′(n) and v₁′(n) such that
u′₁(n)=u₁(n)e^{jφ}v′₁(n)=v₁(n)e^{-jφ}, and
φ=−arg(u₁^{H}(n)u₁(n−1)).

21. The apparatus of claim 18, further comprising a combiner adapted to combine at least a part of physical channels between a Mobile Station (MS) and a Base Station (BS) before the SVD of the channel matrix H.

22. An apparatus for reducing a channel updating rate in a communication system, comprising:
a Singular Value Decomposition (SVD) calculator adapted to acquire a channel matrix H representing a channel status of physical channels and outputting eigenvectors of the channel matrix H by SVD of the channel matrix H; and
a re-orderer adapted to, when an unwanted eigenvector swap is detected in the channel matrix H, re-order the eigenvectors.

23. The apparatus of claim 22, wherein, when elements g₁₁ and g₂₂ of a matrix G calculated by the following equation are equal,
G=H^{H}H,
the re-orderer adapts to determine that the unwanted eigenvector swap has occurred.

24. The apparatus of claim 22, further comprising a combiner adapted to combine at least a part of physical channels between a Mobile Station (MS) and a Base Station (BS) before the SVD of the channel matrix H.
